(19) United States
(12) Patent Application Publication
(10) Pub. No.: US 2007/0144031 A1
(43) Pub. Date: Jun. 28, 2007

(54) Condensing type dryer and controlling method of the same

(76) Inventor: Soon Jo Lee, Changwon-si (KR)

Correspondence Address: BIRCH STEWART KOLASCH & BIRCH, PO BOX 747, FALLS CHURCH, VA, 22040-0747, US

(21) Appl. No.: 10/583,861

(22) PCT Filed: Oct. 14, 2005
(86) PCT No.: PCT/KR05/03439

§ 371 Date: Jun. 21, 2006

(30) Foreign Application Priority Data
Oct. 14, 2004 (KR) 10-2004-0081999

(51) Int. Cl. F26B 3/00

(52) U.S. Cl. 34/446

(57) ABSTRACT

There are provided a condenser type dryer and a method of controlling the same. The method of controlling the condenser type dryer having a drum (12) and a humidity detecting unit (100) includes selecting a desired drying course and a desired degree of dryness, detecting a humidity of objects, which are loaded in the drum (12) to be dried, through the humidity detecting unit (100) while a drying cycle is performed according to the desired drying course and degree of the dryness, and controlling the drying cycle according to if there is a lowest value of the detected value for a predetermined time.

### TECHNICAL FIELD

The present invention relates to a dryer, and more particularly, to a condensing type dryer that can improve the drying performance by accurately detecting even a small amount of load in a drum and a method of controlling the same.

### BACKGROUND ART

Generally, a washing machine, a dryer and a washing machine with a drying function, all of which have a drum assembly, are apparatuses using rotational motion of a drum. That is, as the drum rotates, laundry rotates together with the rotation of the drum, by which the laundry lifts and falls.

For example, in a drum type washing machine, as the laundry lifts and falls, it collides with washing water. By the collision, dirt adhered to the laundry is removed from the laundry.

In a drum type dryer, a hot wind generated by an electric heater or a gas burning device is sent into the drum to absorb moisture remaining in an object that is to be dried, thereby drying the object.

In a prior condensing type dryer, an electrode sensor is used to sense a degree of dryness of the object. The electrode sensor is installed on a predetermined location in the drum. Considering that a deviation of signals from the electrode sensor is severe, in order to realize the precise control, the degree of the dryness has been detected by determining a sensing value according to a method where a datum is drawn away when a new datum is inputted after data are accumulated for a predetermined time and a predetermined time has lapsed.

### DISCLOSURE OF INVENTION

### Technical Problem

The above-described prior method has an advantage of accurately determining a point of drying ending time. However, when there is a small amount of objects, which are to be dried, in the drum, the number of times the objects contact the electrode sensor is reduced. In this case, the drying cycle may be stopped by erroneously determining that the drying is completely done even when the drying is not actually completed. Therefore, the rate of bad drying is increased. This causes the dissatisfaction of the user.

### TECHNICAL SOLUTION

An object of the present invention is to provide a condensing type dryer that can improve the drying performance by accurately detecting objects, which are to be dried and loaded in a drum, even when an amount of the objects is small and a method of controlling such a condensing type dryer.

According to an aspect of the present invention, there is provided a condenser type dryer including: a key input unit for selecting a drying course and a degree of dryness; a humidity detecting unit for detecting a humidity of objects, which are loaded in a drum to be dried, during a drying cycle corresponding to the selected drying course and degree of the dryness; and a control unit for determining if a lowest value is detected for a predetermined time by the humidity detecting unit and controlling the drying cycle such that an addition drying cycle is further performed for a predetermined drying time corresponding to an amount of the objects according to the determination if the lowest value is detected for the predetermined time by the humidity detecting unit.

According to another aspect of the present invention, there is provided a method of controlling a condenser type dryer having a drum and a humidity detecting unit, the method including: selecting a desired drying course and a desired degree of dryness; detecting a humidity of objects, which are loaded in the drum to be dried, through the humidity detecting unit while a drying cycle is performed according to the desired drying course and degree of the dryness; and controlling the drying cycle according to if there is a lowest value of the detected value for a predetermined time.

According to still another aspect of the present invention, there is provided a method of controlling a condenser type dryer having a drum and a humidity detecting unit, the method including: detecting a humidity of objects, which are loaded in the drum to be dried, through the humidity detecting unit; and controlling a drying cycle according to if there is a lowest value of the detected value for a predetermined time.

### ADVANTAGEOUS EFFECTS

The condensing type dryer and method of controlling the same according to the present invention have the following advantages.

First, since the inventive dryer and method are designed to detect even a minute load, the drying can be more accurately realized.

Second, since the inventive dryer and method can detect an object load even when a small amount of the objects are loaded in the drum and perform the drying cycle according to the detection result, the bad drying can be prevented in advance.

Third, since a point of the drying ending time can be differently set depending on the objects, the drying performance can be improved.

It is to be understood that both the foregoing general description and the following detailed description of the present invention are exemplary and explanatory and are intended to provide further explanation of the invention as claimed.

### BRIEF DESCRIPTION OF THE DRAWINGS

FIG. 1 is a sectional view of a condenser type dryer according to an embodiment of the present invention;

FIG. 2 is a block diagram illustrating a control structure of a condenser type dryer according to an embodiment of the present invention; and

FIG. 3 is a flowchart illustrating a method of controlling a condenser type dryer according to an embodiment of the present invention.

### BEST MODE FOR CARRYING OUT THE INVENTION

Reference will now be made in detail to the preferred embodiments of the present invention, examples of which are illustrated in the accompanying drawings. Wherever possible, the same reference numbers will be used throughout the drawings to refer to the same or like parts.

The present invention relates to a dryer for drying objects that will be dried (hereinafter referred as objects) using a rotational drum. Therefore, a drum assembly used in the dryer will be exampled in the following description.

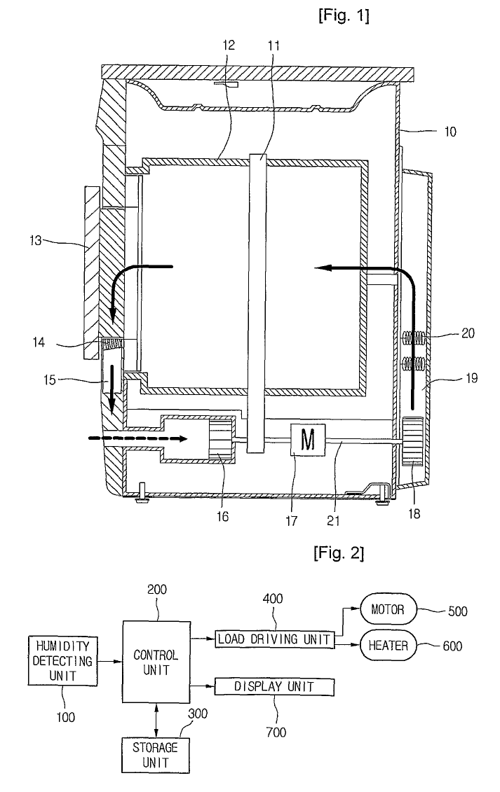

FIG. 1 illustrates a sectional view of a condenser type dryer according to an embodiment of the present invention.

Referring to FIG. 1, a condenser-type dryer includes a cabinet 10 defining an outer appearance of the dryer, a cylindrical drum 12 mounted in the cabinet 10, a door 13 controlling the opening of the drum 12, and a belt 11 disposed around an outer circumference of the drum 100.

The condenser type dryer further includes a motor shaft 21 connected to the belt 11, a motor 17 for transmitting the rotational force to the motor shaft 21, and a cooling fan 16 connected to a first end of the motor shaft 21 to rotate by receiving the rotational force of the motor 17 and intake interior air.

The condenser type dryer further includes a dry fan 18 connected to a second end of the motor shaft 15 to circulate air in the drum 12, a dry duct 19 defining a passage for transmitting air introduced by the dry fan 18 to the drum 100, and a heat generating unit 20 mounted in the dry duct 19.

The condenser type dryer further includes a lint filter 14 disposed below an opening in which the door 13 is inserted to primarily filter foreign objects contained in the circulating air and a circulation duct 15 defining a passage along which the circulating air passing through the lint filter 14 is directed to a condenser (not shown).

The operation of the above-described condenser type dryer will be described hereinafter.

When electric power is applied to the condenser type dryer, the motor 17 is operated and the heater 20 mounted in the dry duct 19 is heated. Then, the belt 11 connected to the motor shaft 21 rotates to rotate the drum 12. As the drum 12 rotates, the objects in the drum 12 rotate along an inner wall of the drum 12. When the objects lift to an uppermost level, they fall by a self-gravity. Here, the objects lift by a lift (not shown) mounted on the inner wall of the drum 12.

Meanwhile, the dry fan 18 connected to the motor shaft 21 rotates by the rotation of the motor 17 to introduce the circulation air via the lint filter 14. The introduced air flows upward along the dry duct 19 and passes through the heater 20 to be converted into high-temperature/dry air. Then, the air is directed into the drum 12 to absorb the moisture contained in the objects, thereby being converted into the high-temperature/damp air.

The high-temperature/damp air is directed to the condenser along the circulation duct 15 via the lint filter 14.

Meanwhile, as the cooling fan 16 connected to the motor shaft 21 rotates, interior air out of the dryer is induced into the dryer. The introduced interior air is directed to the condenser via the cooling fan 16.

Here, the high-temperature/damp air directed to the condenser along the circulation duct 15 and the interior air introduced by the cooling fan 16 and directed to the condenser pass through the condenser while crossing each other. At this point, by the shape property of the condenser, the high-temperature/damp air and the interior air are not mixed with each other but heat-exchanged.

Accordingly, the high-temperature/damp air gives heat to the interior air as it goes through the condenser, thereby being changed into low-temperature/damp air, in the coursed of which the moisture contained in the low-temperature/damp air is condensed. The condensed moisture is dropt on the surface of the condenser and is then directed to a sump (not shown) where the condensed water is accumulated.

The moisture directed to the sump is transmitted to a condensed water storage drawer (not shown) disposed on an upper portion of the dryer. Meanwhile, the interior air passing trough the condenser 200 takes the heat from the high-temperature/damp air to change the circulation air into the low-temperature/damp air. As a result, the temperature of the interior air is increased.

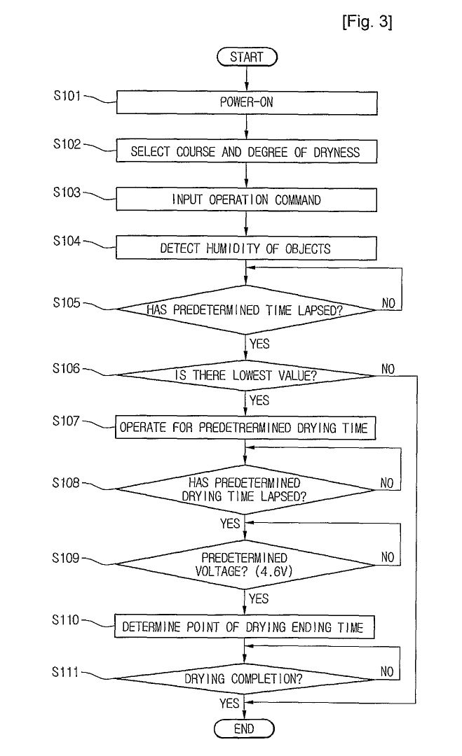

FIG. 2 shows a block diagram illustrating a control structure of the condenser type dryer according to an embodiment of the present invention and FIG. 3 shows a flowchart illustrating a method of controlling the condenser type dryer according to an embodiment of the present invention.

As shown in FIG. 2, the condenser type dryer according to the present invention includes a key input unit (not shown) for selecting a drying course and a degree of the dryness, a humidity detecting unit 10 for detecting a humidity of the objects loaded in the drum, a control unit 200 for determining an amount of the objects loaded in the drum according to if a lowest value is detected for a predetermined time by the humidity detecting unit 100 and controlling a drying cycle in response to the drying course that is selected through the key input part according to the detected amount of the objects, a load driving unit 400 for controlling a motor and a heater 600 according to a signal from the control unit 200, a storage unit 300, and a display unit 700 for displaying the operation state of the dryer.

A user inputs an operation command after inputting a power-on command, a desired drying course and a desired degree of the dryness through the key input unit.

The control unit 200 outputs a control command so that the dryer can be operated according to the desired drying course and degree of the dryness that are selected by the user, and at the same time, determines the amount of the objects by detecting the humidity of the objects loaded in the drum through the humidity detecting unit 100, according to of which the control unit 200 varies the control operation.

At this point, as the control unit 200 is provided to determines if the lowest value is detected for the predetermined time (10 minutes) through the humidity detecting unit 100. When the lowest value is detected even for once, the control unit 200 determines that there is a minimum drying load.

Therefore, the control unit 200 determines an extent of a drying load according to the value detected by the humidity detecting unit 100, resets a point of the drying ending time according to the determined extend of the drying load, and outputs the control command so that the motor 500 and the heater 600 can be driven according to the reset point of the drying ending time.

When the objects are wet towels, the values detected by the humidity detecting unit 100 for the predetermined time (10 minutes) according to the amount of the objects loaded in the drum are illustrated in the following table 1.

TABLE 1

| OPERATION | WET TOWEL (2 | WET TOWEL (4 | WET TOWEL |
|---|---|---|---|
| TIME | PIECES) | PIECES) | (6PIECES) |
| 30″ | 238 | 197 | 222 |
| 1′00″ | 238 | 238 | 239 |
| 1′30″ | 238 | 238 | 239 |
| 1′40″ | 238 | 238 | 239 |
| 1′50″ | 238 | 238 | 239 |
| 2′00″ | 238 | 238 | 239 |
| 2′10″ | 238 | 213 | 200 |
| 2′20″ | 238 | 238 | 213 |
| 2′30″ | 238 | 216 | 239 |
| 2′40″ | 238 | 238 | 239 |
| 2′50″ | 238 | 221 | 220 |
| 3′00 | 238 | 238 | 239 |
| 3′10″ | 238 | 223 | 239 |
| 3′20″ | 238 | 217 | 239 |
| 3′30″ | 238 | 221 | 239 |
| 3′40″ | 238 | 238 | 239 |
| 3′50″ | 238 | 238 | 239 |
| 4′00″ | 238 | 238 | 239 |
| 4′10″ | 238 | 238 | 239 |
| 4′20″ | 238 | 238 | 239 |
| 4′30″ | 238 | 238 | 239 |
| 4′40″ | 238 | 238 | 239 |
| 4′50″ | 238 | 238 | 223 |
| 5′00″ | 238 | 238 | 239 |
| 5′10″ | 238 | 238 | 239 |
| 5′20″ | 238 | 238 | 239 |
| 5′30″ | 238 | 199 | 239 |
| 5′40″ | 220 | 192 | 239 |
| 5′50″ | 238 | 217 | 239 |
| 6′00″ | 238 | 238 | 239 |
| 6′10″ | 232 | 219 | 239 |
| 6′20″ | 238 | 219 | 239 |
| 6′30″ | 238 | 238 | 239 |
| 6′40″ | 238 | 238 | 239 |
| 6′50″ | 238 | 238 | 239 |
| 7′00″ | 238 | 238 | 239 |
| 7′10″ | 238 | 238 | 239 |
| 7′20″ | 238 | 220 | 239 |
| 7′30″ | 238 | 238 | 239 |
| 7′40″ | 238 | 238 | 239 |
| 7′50″ | 218 | 238 | 239 |
| 8′00″ | 238 | 238 | 239 |
| 8′10″ | 238 | 238 | 239 |
| 8′20″ | 238 | 238 | 239 |
| 8′30″ | 238 | 238 | 239 |
| 8′40″ | 238 | 238 | 239 |
| 8′50″ | 238 | 238 | 239 |
| 9′00″ | 238 | 238 | 239 |
| 9′10″ | 238 | 238 | 239 |

As illustrated in Table 1, when the number of towels is 2, the load is very small. Therefore, it is normal that the detected value is about 237. However, the detected value may values such as 220, 232 and 218 that are less than 238 according to spreading states of the towels. Even in this case, it is not determined that there is no towel but there is a load. Therefore, since the drying process must be performed even for the minimum load, after the dryer is operated for a minimum operation time, the point of the drying ending time can be determined according to the drying course and degree of the dryness that are selected by the user.

A method of controlling the above-described condenser type dryer will be now described with reference to FIG. 3.

The user inputs a power-on command (S101), after which inputs a desired drying course and a desired degree of dryness (S102).

When the user inputs an operation command (S103), the humidity of the objects is detected for a predetermined time (S104) It is determined if the predetermined time has lapsed (S105). When the predetermined time has lapsed, it is determined if the lowest detected value is detected for the predetermined time (S106). When it is determined that the lowest detected value is detected, the dryer is operated for a predetermined operation time (107). Then, it is determined if the predetermined operation time has lapsed (S108). When the predetermined operation time has lapsed, it is determined if a voltage reaches a predetermined voltage (S109). When the voltage reaches the predetermined voltage, a point of drying ending time is determined (S110). Then, it is determined if the drying is completed (S11). When the drying is completed, the drying process is ended.

As described above, the condenser type dryer and the control method thereof are designed to determine the point of the drying ending time by determining if there is the lowest value for a predetermined initial drying time (10 minutes), determining there is a drying load when the lowest value is detected even for once, being operated for a predetermined operation time (a minimum operation time for drying the objects), and determining if the drying is completed.

The condensing type dryer and the control method thereof according to the present invention have the following advantages.

First, since the inventive dryer and method are designed to detect even a minute load, the drying can be more accurately realized.

Second, since the inventive dryer and method can detect an object load even when a small amount of the objects are loaded in the drum and perform the drying cycle according to the detection result, the bad drying can be prevented in advance.

Third, since a point of the drying ending time can be differently set depending on the objects, the drying performance can be improved.

It will be apparent to those skilled in the art that various modifications and variations can be made in the present invention. Thus, it is intended that the present invention covers the modifications and variations of this invention provided they come within the scope of the appended claims and their equivalents.

### INDUSTRIAL APPLICABILITY

As the inventive condenser type dryer and the control method thereof can reduce the bad drying and improve the drying performance, the industrial applicability of the present invention is very high.

1. A condenser type dryer comprising:
a key input unit for selecting a drying course and a degree of dryness;
a humidity detecting unit for detecting a humidity of objects, which are loaded in
a drum to be dried, during a drying cycle corresponding to the selected drying course and degree of the dryness; and
a control unit for determining if a lowest value is detected for a predetermined time by the humidity detecting unit and controlling the drying cycle such that an addition drying cycle is further performed for a predetermined drying time corresponding to an amount of the objects according to the determination if the lowest value is detected for the predetermined time by the humidity detecting unit.

2. The condenser type dryer according to claim 1, wherein when the lowest value is detected, the control unit controls such that the drying cycle corresponding to the drying course selected through the key input part can be further performed.

3. The condenser type dryer according to claim 1, wherein when the lowest value is detected, the control unit determines an amount of the objects loaded in the drum.

4. The condenser type laundry dryer according to claim 1, wherein the predetermined time with respect to the lowest value is countered from the beginning of the drying cycle corresponding to the drying course and degree of the dryness.

5. The condenser type dryer according to claim 4, wherein the predetermined time is about 10 minutes.

6. The condenser type dryer according to claim 1, further comprising a load driving unit for controlling a load according to a control signal from the control unit.

7. The condenser type dryer according to claim 1, wherein the humidity detecting unit is formed of an electrode sensor.

8. A method of controlling a condenser type dryer having a drum and a humidity detecting unit, the method comprising:
selecting a desired drying course and a desired degree of dryness;
detecting a humidity of objects, which are loaded in the drum to be dried, through the humidity detecting unit while a drying cycle is performed according to the desired drying course and degree of the dryness; and
controlling the drying cycle according to if there is a lowest value of the detected value for a predetermined time.

9. The method according to claim 8, wherein the controlling the drying cycle comprises performing an additional drying cycle for a predetermined drying time when there is the lowest value of the detected value for the predetermined time.

10. The method according to claim 9, further comprising determining a point of drying ending time when a voltage reaches a predetermined voltage after the additional drying cycle is performed.

11. The method according to claim 9, wherein the predetermined time with respect to the lowest value is countered from the beginning of the drying cycle corresponding to the drying course and degree of the dryness.

12. The method according to claim 9, wherein the predetermined time is about 10 minutes.

13. The method according to claim 8, wherein the controlling the drying cycle comprises determining an amount of the objects loaded in the drum when the lowest value is detected.

14. A method of controlling a condenser type dryer having a drum and a humidity detecting unit, the method comprising:
detecting a humidity of objects, which are loaded in the drum to be dried, through the humidity detecting unit; and
controlling a drying cycle according to if there is a lowest value of the detected value for a predetermined time.

15. The method according to claim 14, further comprising, before the detecting the humidity is performed, selecting a desired drying course and a desired degree of dryness and performing the drying cycle according to the selected drying course and the desired degree of the dryness.

16. The method according to claim 15, wherein the detecting the humidity is performed while the drying cycle is performed according to the desired drying course and degree of the dryness.

17. The method according to claim 15, wherein the predetermined time with respect to the lowest value is countered from the beginning of the drying cycle corresponding to the drying course and degree of the dryness.

18. The method according to claim 14, wherein the controlling the drying cycle comprises performing the drying cycle for a predetermined drying time when there is the lowest value of the detected value for the predetermined time.

19. The method according to claim 18, further comprising determining a point of drying ending time when a voltage reaches a predetermined voltage after the drying cycle is performed.

20. The method according to claim 14, wherein the controlling the drying cycle comprises determining an amount of the objects loaded in the drum when the lowest value is detected.
